(19) United States
(12) Patent Application Publication
(10) Pub. No.: US 2026/0250494 A1
(43) Pub. Date: Aug. 27, 2026

(54) POLYPROPYLENE COMPOSITION FOR PREPARING A FOAM AND A FOAM COMPRISING THE SAME

(71) Applicant: BOREALIS AG, Vienna (AT)

(72) Inventors: Antti Tapio Tynys, Linz (AT); Norbert Reichelt, Linz (AT)

(21) Appl. No.: 18/993,852

(22) PCT Filed: Jul. 25, 2023
(86) PCT No.: PCT/EP2023/070515

§ 371 Date: Jan. 13, 2025

(30) Foreign Application Priority Data
Jul. 27, 2022 (EP) 22187211.2

(51) Int. Cl. C08L 23/12; C08J 3/22; C08J 9/00; C08J 9/14; C08K 3/34

(52) U.S. Cl. CPC C08L 23/12; C08J 9/0061; C08J 9/141; C08K 3/346; C08J 3/226; C08J 2201/022; C08J 2203/14; C08J 2205/052; C08J 2323/12; C08J 2423/12; C08J 2423/16; C08L 2203/14; C08L 2205/025; C08L 2205/03; C08L 2207/02; C08L 2310/00

(57) ABSTRACT

The present application provides a polypropylene composition for preparing a foam. The polypropylene composition comprises (a) a long chain branched polypropylene, and (b) a linear polypropylene, wherein the linear polypropylene has a melt flow rate MFR₂ (ISO 1133, 2.16 kg load, 230° C.) of at least 15.0 g/10 min, and wherein the linear polypropylene is present in the polypropylene composition in an amount of at least 30.0 wt. %, based on the total weight of the polypropylene composition. The present application further relates to a foam comprising said polypropylene composition.

### TECHNICAL FIELD

The present application relates to a polypropylene composition for preparing a foam. The present application further relates to a foam comprising said polypropylene composition or being obtainable from said polypropylene composition.

### BACKGROUND

Long chain branched polypropylenes are known for their combination of high melt strength and high melt extensibility. This combination of properties which makes those materials particularly useful for foaming applications, like the preparation of low density foam.

Polypropylene foams are known in the art. WO 2021/260097 A1 relates to foamed sheets formed from a polypropylene composition comprising 10 to 50 wt. % of recycled polypropylene and/or linear polypropylene; 40 to 89.95 wt. % of a high melt strength polypropylene having an F30 melt strength of more than 25.0 cN and a v30 melt extensibility of more than 205 mm/s; and 0.05 to 10 wt. % of a nucleating agent (NA).

US 2005/0165165 A1 describes a polymeric composition to be used in producing foam in which the polymeric composition comprises conventional linear polypropylene, high melt strength polypropylene and a rheology modifier resin. The conventional linear polypropylene is present in an amount of from about 1 to 25 weight percent of the polymeric composition. The high melt strength polypropylene is in the amount of from about 51 to 85 weight percent of the polymeric composition. The rheology modifier resin is a member of the group of styrene-olefin copolymers.

For obtaining good foamability and a high quality foam, the typical approach in the art has been to maximize the melt strength and the melt extensibility of long chain branched polypropylenes or compositions containing the same for good foaming.

However, increasing the melt strength decreases markedly the melt flow rate of the polymer. A low melt flow rate in turn limits the processability of the polymer when using standard extrusion foaming conditions. In order to process a polymer composition having low viscosity (i.e. a low melt flow rate) at low shear, the output of the extruder can be decreased and/or the size of the extruder can be increased while keeping the same output level. However, both approaches are expensive and often not economically feasible.

In order to avoid the processing challenges of low melt flow rate polypropylene composition and/or to increase the output of the existing polypropylene foaming lines, a foamable polypropylene composition with good processability is needed. At the same time, the foamable polypropylene composition should be suitable to provide a high quality foam, like a high quality low density foam, which has good mechanical properties. Typically, a high quality foam has a low number of open cells, which is an indication for a good cell structure.

One object of the present invention is to provide a polypropylene composition for preparing a foam. One object of the present invention is to provide a foam comprising a polypropylene composition.

### SUMMARY OF INVENTION

One aspect of the present invention provides a polypropylene composition for preparing a foam. The polypropylene composition comprises
(a) a long chain branched polypropylene, and
(b) a linear polypropylene,
wherein the linear polypropylene has a melt flow rate MFR₂ (ISO 1133, 2.16 kg load, 230° C.) of at least 15.0 g/10 min, and
wherein the linear polypropylene is present in the polypropylene composition in an amount of at least 30.0 wt. %, based on the total weight of the polypropylene composition.

One finding of the inventors is that the polypropylene composition as described herein is suitable to prepare a foam of good quality, and specifically a low density foam of good quality. The polypropylene composition can be used to prepare a foam having good and/or improved mechanical properties, like tensile strength and elongation at break, especially in machine direction, in combination with a good cell structure. When the inventive polypropylene composition is foamed, better processability due to a comparatively high melt flow rate can be observed. This can contribute to lower pressure levels in the extruders. The viscosity of the polypropylene composition can enable the converter to reach lower melt temperatures, and thereby lower densities of the foam.

These findings were surprising because the use of high amounts of a high melt flow rate linear polypropylene in combination with a long chain branched polypropylene was expected to have a significant negative effect on the melt strength of the polypropylene composition, thereby deteriorating the quality of the foamed product.

Another aspect of the present invention provides a foam. The foam comprises the polypropylene composition according to one embodiment of the invention.

According to one preferred embodiment of the invention, a foam is provided having a density of at most 100 kg/m³ and comprising a polypropylene composition, the polypropylene composition comprising
(a) a long chain branched polypropylene, and
(b) a linear polypropylene,
wherein the linear polypropylene has a melt flow rate MFR₂ (ISO 1133, 2.16 kg load, 230° C.) of at least 15.0 g/10 min, and
wherein the linear polypropylene is present in the polypropylene composition in an amount of at least 30.0 wt. %, based on the total weight of the polypropylene composition.

Alternatively, the foam is obtainable or obtained from the polypropylene composition according to one embodiment of the invention.

Another aspect of the present invention provides a use of the polypropylene composition according to one embodiment of the invention for preparing a foam.

Another aspect of the invention provides a process for preparing a foam. The process comprises the steps of:
a) providing a polypropylene composition according to one embodiment of the invention;
b) foaming the polypropylene composition provided in step a) to obtain a foam.

According to one preferred embodiment of the invention, a process is provided for preparing a foam having a density of at most 100 kg/m³ and comprising a polypropylene composition, the polypropylene composition comprising
(a) a long chain branched polypropylene, and
(b) a linear polypropylene,
wherein the linear polypropylene has a melt flow rate MFR₂ (ISO 1133, 2.16 kg load, 230° C.) of at least 15.0 g/10 min, and
wherein the linear polypropylene is present in the polypropylene composition in an amount of at least 30.0 wt. %, based on the total weight of the polypropylene composition, wherein the process comprises the steps of:
a) providing a polypropylene composition, the polypropylene composition comprising
   (a) a long chain branched polypropylene,
   (b) a linear polypropylene having a melt flow rate MFR₂ (ISO 1133, 2.16 kg load, 230° C.) of at least 15.0 g/10 min and being present in the polypropylene composition in an amount of at least 30.0 wt. %, based on the total weight of the polypropylene composition; and
b) foaming the polypropylene composition provided in step a) to obtain a foam.

According to one embodiment of the invention, the polypropylene composition comprises:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) optionally 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and optionally wherein the components (a) to (c) add up to 100 wt. %.

According to one embodiment of the invention, the polypropylene composition does not contain a styrene-based polymer.

According to one embodiment of the invention, the polypropylene composition has a melt flow rate MFR₂ (ISO 1133, 2.16 kg load, 230° C.) in the range of 6.0 to 30.0 g/10 min, and preferably in the range of 6.0 to 25.0 g/10 min.

According to one embodiment of the invention, the long chain branched polypropylene is a long chain branched polypropylene homopolymer.

According to one embodiment of the invention, the long chain branched polypropylene is obtained by treating a linear polypropylene with a radical forming agent, preferably in the presence of bifunctionally unsaturated monomer(s) and/or multifunctionally unsaturated low molecular weight polymer(s).

According to one embodiment of the invention, the linear polypropylene is a heterophasic polypropylene composition comprising
a matrix being a polypropylene, preferably a propylene homopolymer or a propylene copolymer, and
an elastomeric ethylene copolymer, preferably a C2C3 copolymer, dispersed in said matrix.

According to one embodiment of the invention, the heterophasic polypropylene composition has a xylene cold soluble fraction (according to ISO 16152 at 25° C.) in the range of 10.0 to 45.0 wt. %, preferably in the range of 12.0 to 30.0 wt. %, and more preferably in the range of 12.0 to 22.0 wt. %, based on the total weight of the heterophasic polypropylene composition.

According to one embodiment of the invention, the elastomeric ethylene copolymer, preferably the C2C3 copolymer, has an ethylene content in the range of 25.0 to 70.0 wt. %, preferably in the range of 25.0 to 65.0 wt. %, more preferably in the range of 28.0 to 58.0 wt. %, based on the total weight of the elastomeric ethylene copolymer.

According to one embodiment of the invention, the long chain branched polypropylene has one or more of, preferably two or more of, and more preferably all of, the following properties:
i) a melt strength F30 (ISO 16790:2005) of 20.0 to 50.0 cN, preferably in the range of 25.0 to 45.0 cN, and more preferably in the range of 30.0 to 40.0 cN,
ii) a melt extensibility V30 (ISO 16790:2005) in the range of 190 to 320 mm/s, preferably 210 to 300 mm/s, and more preferably 230 to 280 mm/s,
iii) a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min.

According to one embodiment of the invention, the linear polypropylene has a melt flow rate MFR₂ (ISO 1133, 2.16 kg load, 230° C.) in the range of 15.0 to 125.0 g/10 min, preferably 20.0 to 100.0 g/10 min, more preferably 25.0 to 70.0 g/10 min, and most preferably 25.0 to 40.0 g/10 min.

According to one embodiment of the invention, the foam has a density of at most 100 kg/m³, and preferably in the range of 30 to 100 kg/m³.

According to one embodiment of the invention, the foam has one or both of the following properties:
i) a melt strength F30 (ISO 16790:2005) of at most 20.0 cN,
ii) a shear thinning index SHI (0.05/300), determined as described in the specification, of at most 40.0, preferably in the range from 10.0 to 35.0, and more preferably in the range of 10.0 to 30.0.

According to one embodiment of the invention, the foam has one or more of, preferably two or more of, and more preferably all of, the following properties:
i) an open cell content of at most 50%, preferably in the range of 5 to 45%, measured according to ASTM D6226,
ii) an elongation at break of at least 10%, preferably in the range of 10 to 20%, measured in machine direction (MD) according to ISO 1798, and
iii) a tensile strength of at least 1050 kPa, preferably in the range of 1050 to 2000 kPa, measured in machine direction (MD) according to ISO 1798.

Where the term “comprising” is used in the present description and claims, it does not exclude other non-specified elements of major or minor functional importance. For the purposes of the present invention, the term “essentially consisting of” and “consisting of” are considered to be specific embodiments of the term “comprising of”. If hereinafter a group is defined to comprise at least a certain number of features or embodiments, this is also to be understood to disclose a group, which optionally essentially consists only of these features or embodiments or consists only of these features or embodiments. Whenever the terms 30 “including” or “having” are used, these terms are meant to be equivalent to “comprising” as defined above.

In the following, the present invention is described in more detail.

### DETAILED DESCRIPTION

### Polypropylene Composition for Preparing a Foam

One aspect of the present invention provides a polypropylene composition for preparing a foam. The polypropylene composition comprises
(a) a long chain branched polypropylene, and
(b) a linear polypropylene.

The linear polypropylene has a melt flow rate MFR₂ (ISO 1133, 2.16 kg load, 230° C.) of at least 15.0 g/10 min. The linear polypropylene is present in the polypropylene composition in an amount of at least 30.0 wt. %, based on the total weight of the polypropylene composition.

The polypropylene composition provided herein is suitable for preparing a foam. “Suitable for preparing a foam” includes those polypropylene compositions which can be foamed by using a physical foaming agent which is externally provided, e.g. in an extrusion foaming process. Thus, “suitable for preparing a foam” is not to be understood in that the polypropylene composition necessarily contains a foaming agent (although this is possible).

According to one preferred embodiment, the polypropylene composition is suitable for preparing a foam by means of an extrusion foaming process using a physical foaming agent (e.g. a gas like butane).

The polypropylene composition is not only suitable for, or limited to, preparing a foam. Other applications and uses of the polypropylene composition provided herein are also conceivable and are not excluded.

### Long Chain Branched Polypropylene (a)

The polypropylene composition comprises a long chain branched polypropylene as a component (a). The long chain branched polypropylene being present in the polypropylene composition according to the invention is also referred to herein as “long chain branched polypropylene (a)”.

Long chain branched polypropylenes are known in the art. Long chain branched polypropylene differs from a linear polypropylene in that the polypropylene backbone contains long side chains whereas a non-branched polypropylene, i.e. a linear polypropylene, does not contain long side chains. The long side chains branching out from the polymer backbone have significant impact on the rheology of the polypropylene. Accordingly, linear polypropylenes and long chain branched polypropylenes can be clearly distinguished by e.g. their flow behavior under stress (e.g. a ratio of polymer melt viscosities measured under differing loads). Additionally or alternatively, long chain branching can be determined by analysing the content of long chain branches by NMR and/or by measuring the long chain branching index g′ by using e.g. SEC/VISC-LS (size exclusion chromatography/viscometry-light scattering) as known in the art. Branching index g′ is a parameter of the degree of branching. The branching index g′ correlates with the amount of branches of a polymer. A low g′-value is an indicator for a highly branched polymer. In other words, if the g′-value decreases, the branching of the polypropylene increases. For instance, the value of g′ of at least 0.96, such as at least 0.97 or at least 0.98 typically indicates that long chain branches are not present. On the other hand, a value of g′ of 0.9 or less (e.g. 0.6 to 0.9), such as 0.8 or less, typically indicates that the polymer contains long chain branches. Further details regarding branching index g′ and methods for its determination are described, for example, in the section “Measuring methods” of EP3280748B1, which is incorporated herein by reference.

Due to the specific melt strength properties, long chain branched polypropylenes are also referred to in the art as high melt strength polypropylenes.

Long chain branching can be generally achieved by using specific catalysts, i.e. specific single-site and/or metallocene catalysts, or by chemical modification. Concerning the preparation of a long chain branched polypropylene obtained by the use of a specific catalyst reference is made to EP 1 892 264. With regard to a long chain branched polypropylene obtained by chemical modification it is referred to, for instance, EP 0 787 750, EP 0 879 830 A1 and EP 0 890 612 A2.

Long chain branched polypropylenes typically have a comparatively low melt flow rate combined with high melt strength and a high melt extensibility.

The polypropylene composition comprises at least one long chain branched polypropylene (a), like from one to three long chain branched polypropylene (a). For example, the polypropylene composition can comprise one long chain branched polypropylene (a).

The long chain branched polypropylene (a) is principally not limited as long as it is suitable for preparing the polypropylene composition according to one embodiment of the invention.

The long chain branched polypropylene is not specifically limited in terms of the linear polypropylene which forms its longest chain or backbone. The long chain branched polypropylene (a) can be a long chain branched propylene copolymer or a long chain branched propylene homopolymer.

The long chain branched polypropylene (a) may be a long chain branched propylene copolymer, like a long chain branched propylene random copolymer. In case the long chain branched polypropylene (a) is a propylene copolymer, it may comprise comonomers selected from the group consisting of ethylene and/or C₄ to C₁₀ α-olefins, e.g. 1-butene and/or 1-hexene, with ethylene and/or 1-butene being preferred. For example, the long chain branched propylene copolymer may be a long chain branched C2C3 copolymer.

The comonomer content of the long chain branched propylene copolymer may be in the range of more than 0.5 to 10.0 mol %, still more preferably in the range of more than 0.5 to 7.0 mol %.

It is preferred that the long chain branched polypropylene (a) is a long chain branched propylene homopolymer. Hence, according to one preferred embodiment of the invention, the long chain branched polypropylene (a) is a long chain branched propylene homopolymer.

In case the long chain branched polypropylene is a long chain branched polypropylene which is obtained by chemical modification of a linear polypropylene, the definition of propylene homopolymer and propylene copolymer is to be understood to refer to the linear polypropylene which is used to obtain the long chain branched polypropylene by chemical modification, e.g. with bifunctionally unsaturated monomer(s) and/or multifunctionally unsaturated low molecular weight polymer(s) in reactive extrusion.

The polypropylene composition typically comprises a specific minimum amount of long chain branched polypropylene to impart sufficient melt strength to the composition.

The polypropylene composition typically comprises at least 20.0 wt. % of the long chain branched polypropylene (a), based on the total weight of the polypropylene composition. Preferably, the polypropylene composition comprises at least 30.0 wt. %, more preferably at least 35.0 wt. %, and even more preferably at least 37.5 wt. %, of the long chain branched polypropylene, based on the total weight of the polypropylene composition.

It is more preferred that the polypropylene composition comprises 20.0 to 70.0 wt. %, even more preferably 30.0 to 70.0 wt. %, yet even more preferably 35.0 to 65.0 wt. %, like in the range of 37.5 to 62.5 wt. %, of the long chain branched polypropylene (a), based on the total weight of the polypropylene composition.

The long chain branched polypropylene (a) has preferably specific properties like viscosity, melt strength, and the like.

The long chain branched polypropylene (a) preferably has a melt strength F30 (ISO 16790:2005) of 20.0 to 50.0 cN, preferably in the range of 25.0 to 45.0 cN, and more preferably in the range of 30.0 to 40.0 cN, like in the range of 32.0 to 38.0 cN.

The long chain branched polypropylene (a) preferably has a melt extensibility V30 (ISO 16790:2005) in the range of 190 to 320 mm/s, preferably 210 to 300 mm/s, and more preferably 230 to 280 mm/s, like in the range of 240 to 280 mm/s.

The long chain branched polypropylene (a) preferably has a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min, like in the range of 1.4 to 2.3 g/10 min.

According to one preferred embodiment, the long chain branched polypropylene (a) has two or more, and more preferably all, of the following properties:
i) a melt strength F30 (ISO 16790:2005) of 20.0 to 50.0 cN, preferably in the range of 25.0 to 45.0 cN, and more preferably in the range of 30.0 to 40.0 cN, like in the range of 32.0 to 38.0 cN,
ii) a melt extensibility V30 (ISO 16790:2005) in the range of 190 to 320 mm/s, preferably 210 to 300 mm/s, and more preferably 230 to 280 mm/s, like in the range of 240 to 280 mm/s,
iii) a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min, like in the range of 1.4 to 2.3 g/10 min.

The long chain branched polypropylene (a) can have a melting point of at least 130° C., more preferably of at least 135° C. and most preferably of at least 140° C. The crystallization temperature may be at least 110° C., more preferably at least 120° C.

The long chain branched polypropylene (a) can be obtained by treating linear polypropylene with a radical forming agent, preferably in the presence of bifunctionally unsaturated monomer(s) and/or multifunctionally unsaturated low molecular weight polymer(s).

The radical forming agent may be a peroxide, and preferably is an organic peroxide, like a thermally decomposable organic peroxide. The multifunctionally unsaturated low molecular weight polymer(s) preferably have a number average molecular weight (Mn)≤10000 g/mol. Suitable low molecular weight polymers are polybutadienes, and preferably polybutadienes with a microstructure being partially or predominantly in the 1,2-(vinyl) configuration). The bifunctionally unsaturated monomers may be selected from divinyl compounds, allyl compounds, dienes, and the like. Preferably, the bifunctionally unsaturated monomer is selected from the group consisting of 1,3-butadiene, isoprene, dimethyl butadiene, divinylbenzene, and mixtures thereof. A suitable method to obtain the non-used long chain branched PP, is for instance disclosed in EP 0 787 750 A2, EP 0 879 830 A1 and EP 0 890 612 A2.

A suitable long chain branched polypropylene (a) is WB140HMS™ commercially available from Borealis AG.

### Linear Polypropylene (b)

The polypropylene composition comprises a linear polypropylene as a component (b). The linear polypropylene being present in the polypropylene composition according to the invention is also referred to herein as “linear polypropylene (b)”.

Linear polypropylenes are also known in the art. A linear polypropylene differs from a long chain branched polypropylene in that the polypropylene chain essentially does not contain side chains, i.e. is not branched. A skilled person can distinguish between a linear polypropylene and a long chain branched polypropylene. For example, and as set out above, linear polypropylenes and long chain branched polypropylenes can be clearly distinguished by their flow behavior under stress. The presence of branching in a polypropylene may also be determined, e.g. by determining the branching index, using gel phase chromatography (GPC). As is known in the art, linear polypropylene can be produced, for example, by using a suitable single-site catalyst or a Ziegler Natta catalyst.

It is one requirement that the linear polypropylene (b) has a melt flow rate MFR₂ (ISO 1133, 2.16 kg load, 230° C.) of at least 15.0 g/10 min, preferably at least 20 g/10 min, and more preferably at least 25.0 g/10 min.

According to one preferred embodiment of the invention, the linear polypropylene (b) has a melt flow rate MFR₂ (ISO 1133, 2.16 kg load, 230° C.) in the range of 15.0 to 125.0 g/10 min, preferably 20.0 to 100.0 g/10 min, more preferably 25.0 to 70.0 g/10 min, and most preferably 25.0 to 40.0 g/10 min, like in a range of 28.0 to 36.0 g/10 min.

The polypropylene composition comprises at least one linear polypropylene (b), like from one to three linear polypropylenes (b). The linear polypropylene (b) is principally not limited as long as it fulfils the requirement of the minimum melt flow rate and is suitable for preparing the polypropylene composition according to the invention.

The linear polypropylene (b) is not specifically limited in terms of its chemical composition.

The linear polypropylene (b) may be a propylene copolymer, like a propylene random copolymer. In case the linear polypropylene (b) is a propylene copolymer, it may comprise comonomers selected from the group consisting of ethylene and/or C₄ to C₁₀ α-olefins, e.g. 1-butene and/or 1-hexene, with ethylene and/or 1-butene being preferred. For example, the linear polypropylene (b) may be C2C3 copolymer. The comonomer content of the linear polypropylene (b) may be in the range of more than 0.5 to 10.0 mol %, still more preferably in the range of more than 0.5 to 7.0 mol %.

Alternatively, the linear polypropylene (b) may be a linear propylene homopolymer. Hence, according to one preferred embodiment of the invention, the linear polypropylene (b) is a linear propylene homopolymer.

In one preferred embodiment of the invention, the linear polypropylene (b) is a heterophasic polypropylene composition. Heterophasic polypropylene compositions as such are known in the art.

The heterophasic polypropylene composition preferably comprises a matrix being a polypropylene, more preferably a propylene homo- or copolymer, which is preferably (semi-) crystalline. Dispersed in said matrix is an elastomeric ethylene copolymer. Thus the matrix contains (finely) dispersed inclusions being not part of the matrix and said inclusions contain the elastomeric ethylene copolymer. The term “inclusion” indicates that the matrix and the inclusion form different phases within the heterophasic polypropylene composition. The presence of second phases or the so called inclusions are for instance visible by high resolution microscopy, like electron microscopy or atomic force microscopy, or by dynamic mechanical thermal analysis (DMTA). Specifically, in DMTA the presence of a multiphase structure can be identified by the presence of at least two distinct glass transition temperatures.

According to one embodiment, the heterophasic polypropylene composition comprises a matrix being a propylene homopolymer, and an elastomeric ethylene copolymer being dispersed in said matrix.

It is preferred that the heterophasic polypropylene composition comprises, more preferably consists of,
55.0 to 90.0 wt. %, more preferably 70.0 to 88.0 wt. %, and even more preferably 75.0 to 88.0 wt. %, like in the range of 78.0 to 88.0 wt. %, of the matrix being a polypropylene, and preferably a propylene homopolymer or a propylene copolymer, and
10.0 to 45.0 wt. %, more preferably 12.0 to 30.0 wt. %, and even more preferably in the range of 12.0 to 25.0 wt. %, like in the range of 12.0 to 22.0 wt. %, of the elastomeric ethylene copolymer,
based on the overall weight of the heterophasic polypropylene composition.

For example, the heterophasic polypropylene composition can comprise, preferably consist of, about 82 wt. % of the matrix being a polypropylene, and about 18 wt. % of the elastomeric ethylene copolymer.

The heterophasic polypropylene composition preferably has a xylene cold soluble fraction (according to ISO 16152 at 25° C.) in the range of 10.0 to 45.0 wt. %, preferably in the range of 12.0 to 30.0 wt. %, and more preferably in the range of 12.0 to 22.0 wt. %, based on the total weight of the heterophasic polypropylene composition.

The elastomeric ethylene copolymer can comprise any comonomer which is copolymerizable with ethylene. Preferably, the elastomeric ethylene copolymer is a copolymer of ethylene and at least one monomer selected from the group of C₃ to C₁₂ α-olefins, more preferably selected from the group of propylene, 1-butene, 1-hexene and 1-octene, and most preferably is a copolymer of ethylene and propylene (i.e. a C2C3 copolymer).

The elastomeric ethylene copolymer, preferably the elastomeric C2C3 copolymer, can have an ethylene content in the range of 25.0 to 70.0 wt. %, preferably in the range of 25.0 to 65.0 wt. %, and more preferably in the range of 28.0 to 58.0 wt. %, like in a range of 30.0 to 40.0 wt. % or in a range of 50.0 to 58.0 wt. %, based on the total weight of the elastomeric ethylene copolymer.

For example, the ethylene content of the elastomeric ethylene copolymer, preferably the elastomeric C2C3 copolymer, may be about 54 wt. %, based on the total weight of the elastomeric ethylene copolymer.

According to one more preferred embodiment, the elastomeric ethylene copolymer, preferably the elastomeric C2C3 copolymer, has an ethylene content in a range of 30.0 to 40.0 wt. %, based on the total weight of the elastomeric ethylene copolymer.

A suitable heterophasic polypropylene composition is the product “PP612MK10” which is commercially available from the company SABIC.

The polypropylene composition comprises at least 30.0 wt. % of the linear polypropylene (b), based on the total weight of the polypropylene composition. Preferably, the polypropylene composition comprises at least 35.0 wt. %, and more preferably at least 37.5 wt. %, of the linear polypropylene (b), based on the total weight of the polypropylene composition.

It is more preferred that the polypropylene composition comprises 30.0 to 80.0 wt. %, more preferably 30.0 to 70.0 wt. %, even more preferably 35.0 to 65.0 wt. %, and yet even more preferably 37.5 to 62.5 wt. %, of the linear polypropylene (b), based on the total weight of the polypropylene composition.

### Additives (c)

The polypropylene composition optionally comprises one or more additives as a component (c). The polypropylene composition can comprise one additive or two or more additives, like two to six additives, two to four additives. For example, the polypropylene composition can comprise one or two additives.

The additives may vary depending on the use of the polypropylene composition, the equipment for processing the polypropylene composition, and/or the application of a product, preferably a foam, which comprises the polypropylene composition. Additives can be selected by the person with skill in the art.

It is possible that the polypropylene composition comprises one or more additional polymeric components as additives (c) or as part of the additives (c). The one or more additional polymeric components may be polymeric components which are melt-blendable with the long chain branched polypropylene (a) and the linear polypropylene (b). For example, the additional polymeric component may be a polymeric material which is brought into the polypropylene composition as part of an additive masterbatch, i.e. as polymeric carrier material.

It is however also possible to select the polymeric carrier material of an additive masterbatch to be very similar or essentially identical to one of the components (a) and (b).

The polypropylene composition may be prepared using an additive masterbatch which comprises a nucleating agent and a polymeric carrier resin, like a polypropylene carrier resin. The polymeric carrier resin may be the same as, or different to, the remaining polymeric components (a) or (b).

It is preferred that the polypropylene composition comprises a nucleating agent, such as a talc nucleating agent, as an additive. Nucleating agents are known to the skilled person. According to one preferred embodiment, the polypropylene composition comprises one or more additives as a component (c), wherein the one or more additives comprise a nucleating agent. Preferably, the nucleating agent is a talc.

The polypropylene composition can comprise 0.01 to 10.0 wt. % of the one or more additives (c), based on the total weight of the polypropylene composition.

It is preferred that the polypropylene composition comprises 0.01 to 5.0 wt. %, more preferably 0.1 to 4.0 wt. %, even more preferably 0.2 to 3.0 wt. %, like 0.2 to 2.0 wt. %, of one or more additives (c), based on the total weight of the polypropylene composition.

According to one preferred embodiment, the polypropylene composition comprises 0.01 to 5.0 wt. %, more preferably 0.1 to 4.0 wt. %, even more preferably 0.2 to 3.0 wt. %, like 0.2 to 2.0 wt. %, of one or more additives (c), based on the total weight of the polypropylene composition, with the requirement that the one or more additives (c) comprise a nucleating agent, i.e. with the requirement that a nucleating agent is part of the one or more additives (c) or is the one additive (c). The nucleating agent is preferably a talc.

The one or more additives (c) can comprise the nucleating agent, preferably the talc, in an amount of at least 50.0 wt. %, preferably at least 60.0 wt. % to 100 wt. %, based on the total weight of the one or more additives (c). Remaining parts of the one or more additives (c) can be, but are not limited to, a polymeric carrier resin, e.g. a polypropylene which is suitable for use in a polymer masterbatch.

According to one preferred embodiment, the polypropylene composition comprises 0.01 to 5.0 wt. %, more preferably 0.1 to 4.0 wt. %, even more preferably 0.2 to 3.0 wt. %, like 0.2 to 2.0 wt. %, of a nucleating agent, and preferably a talc nucleating agent, based on the total weight of the polypropylene composition.

### The Polypropylene Composition

The polypropylene composition comprises at least 30.0 wt. % of the linear polypropylene (b), based on the total weight of the polypropylene composition.

Preferably, the polypropylene composition comprises the long chain branched polypropylene (a) and the linear polypropylene (b) in specific weight amounts.

The polypropylene composition can comprise:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene, and
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene,
wherein all weight amounts are based on the total weight of the polypropylene composition.

The polypropylene composition can further comprise other components in addition to components (a) and (b), like other polymeric blending partners.

It is preferred that the polypropylene composition comprises polymeric material, which is different to the at least one long chain branched polypropylene (a) and the at least one linear polypropylene (b), in an amount of at most 10.0 wt. % (e.g. 0.0 to 10.0 wt. %), and optionally at most 5.0 wt. % (e.g. 0.0 to 5.0 wt. %), optionally at most 3.0 wt. % (e.g. 0.0 to 3.0 wt. %), based on the total weight of the polypropylene composition.

For example, the polypropylene composition can comprise polymeric material, which is different to the at least one long chain branched polypropylene (a) and the at least one linear polypropylene (b), in an amount of in the range of 0.2 to 3.0 wt. %, and optionally 0.2 to 2.0 wt. %, based on the total weight of the polypropylene composition. In case the polypropylene composition comprises said minor amounts of an additional polymeric material, said polymeric material may be a polymeric carrier resin of an additive masterbatch.

The polypropylene composition does not need to contain a styrene-based polymer to achieve the beneficial effects described herein. Styrene-based polymers are, for example, hydrogenated styrene-isoprene-styrene block copolymer (SEPS), styrene-butadiene random copolymer, hydrogenated styrene-butadiene random copolymer, styrene-isoprene random copolymer, hydrogenated styrene-isoprene random copolymer, styrene-butadiene block copolymer (SBR), hydrogenated styrene-butadiene block copolymer (SEB, SEBC), styrene-butadiene-styrene block copolymer (SBS), hydrogenated styrene-butadiene-styrene block copolymer (SEBS), styrene-isoprene block copolymer (SIR), hydrogenated styrene-isoprene block copolymer (SEP), styrene-isoprene-styrene block copolymer (SIS), styrene-ethylene copolymer, styrene-propylene copolymer, ethylene-styrene graft copolymer, propylene-styrene graft copolymer, EPM-styrene graft copolymer, EPDM-styrene graft copolymer, and combinations thereof.

Preferably, the polypropylene composition does not contain a styrene-based polymer, like a styrene-based polymer selected from the group described herein above.

It is preferred that the polypropylene composition comprises one or more additives as a component (c).

The polypropylene composition can comprise:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

The polypropylene composition can comprise:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and wherein the components (a) to (c) add up to 100 wt. %.

The polypropylene composition preferably comprises:
(a) 20.0 to 69.99 wt. %, preferably 30.0 to 69.9 wt. %, more preferably 35.0 to 64.8 wt. %, and even more preferably 37.5 to 62.3 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

The polypropylene composition preferably comprises:
(a) 20.0 to 69.99 wt. %, preferably 30.0 to 69.9 wt. %, more preferably 35.0 to 64.8 wt. %, and even more preferably 37.5 to 62.3 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and wherein the components (a) to (c) add up to 100 wt. %.

According to one preferred embodiment, the polypropylene composition comprises, and preferably essentially consists of or consists of:
(a) 20.0 to 69.99 wt. %, preferably 30.0 to 69.9 wt. %, more preferably 35.0 to 64.8 wt. %, and even more preferably 37.5 to 62.3 wt. %, of the long chain branched polypropylene,
(b) 30.0 to 79.99 wt. %, preferably 30.0 to 69.9 wt. %, more preferably 35.0 to 64.8.0 wt. %, and even more preferably 37.5 to 62.3 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition.

In one more specific embodiment, the polypropylene composition comprises:
(a) 55.0 to 64.8 wt. %, like from 57.5 to 62.3 wt. %, of the long chain branched polypropylene,
(b) 35.0 to 44.8 wt. %, like from 37.5 to 62.3 wt. %, of the linear polypropylene, and
(c) 0.2 to 4.0 wt. %, and even more preferably 0.2 to 2.0 wt. %, of one or more additives,
wherein all weight amounts are based on the total weight of the polypropylene composition, and wherein the components (a) to (c) preferably add up to 100 wt. %.

As set out above, the one or more additives (c) preferably comprise a nucleating agent, and more preferably comprise a talc nucleating agent. For example, the polypropylene composition can comprise a nucleating agent, and preferably a talc nucleating agent as a component (c).

The one or more additives (c) can comprise an additional polymeric material, such as an additional polypropylene. For example, the polypropylene composition can comprise a nucleating agent, and preferably a talc nucleating agent, and a polymeric carrier resin, like a polypropylene, as a component (c).

The polypropylene composition is preferably defined by a melt flow rate which is comparatively high for a foamable polypropylene composition.

According to one preferred embodiment of the invention, the polypropylene composition has a melt flow rate MFR₂ (ISO 1133, 2.16 kg load, 230° C.) in the range of 6.0 to 30.0 g/10 min, and preferably in the range of 6.0 to 25.0 g/10 min, like in a range of 6.0 to 15.0 g/10 min.

The polypropylene composition may be provided in melt-mixed form or in form of a dry blend.

According to one embodiment, the polypropylene composition is provided in form of a dry blend, i.e. in form of a dry-blended polypropylene composition. Dry-blended polypropylene compositions are known in the art. The dry blend typically comprises the individual components (a) to (c) as described herein above and further optional components in form of a loose mixture of pellets.

In case the polypropylene composition is provided in form of a dry blend, it can be obtainable or obtained by a dry blending process comprising the mixing of the components as described herein, for example, in a batch dry-blending device.

Alternatively, the polypropylene composition can be provided in melt-mixed form, i.e. in form of a melt-mixed polypropylene composition. In said case, the composition can be obtainable or obtained by a melt-mixing process comprising the mixing of the components described herein, for example, in a batch or a continuous melt-mixing device. The melt-mixing process can be part of an extrusion foaming process, in which the melt-mixed polypropylene composition is provided in an extruder and subsequently to a subsequent foaming step.

A melt-mixed polypropylene composition may be present in a molten form (e.g. in an extruder) or in a solid form.

The polypropylene composition may be provided in form of a dry blend. The dry blend can comprise:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene, and
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, wherein all weight amounts are based on the total weight of the dry blend.

In case the optional one or more additives are present in the dry blend as a component (c), it is preferred that the additive(s) are present in form of an additive masterbatch. Additive masterbatches as such are known to the skilled person.

The dry blend can comprise:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of an additive masterbatch, preferably comprising (i) a nucleating agent, more preferably a talc nucleating, and (ii) a polymeric carrier resin, preferably a propylene carrier resin,
wherein all weight amounts are based on the total weight of the polypropylene dry blend.

The dry blend can comprise:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of an additive masterbatch, preferably comprising (i) a nucleating agent, more preferably a talc nucleating, and (ii) a polymeric carrier resin, preferably a propylene carrier resin,
wherein all weight amounts are based on the total weight of the dry blend, and wherein the components (a) to (c) add up to 100 wt. %.

The dry blend can comprise:
(a) 20.0 to 69.99 wt. %, preferably 30.0 to 69.9 wt. %, more preferably 35.0 to 64.8 wt. %, and even more preferably 37.5 to 62.3 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of an additive masterbatch, preferably comprising (i) a nucleating agent, more preferably a talc nucleating, and (ii) a polymeric carrier resin, preferably a propylene carrier resin,
wherein all weight amounts are based on the total weight of the dry blend.

The dry blend can comprise:
(a) 20.0 to 69.99 wt. %, preferably 30.0 to 69.9 wt. %, more preferably 35.0 to 64.8 wt. %, and even more preferably 37.5 to 62.3 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of an additive masterbatch, preferably comprising (i) a nucleating agent, more preferably a talc nucleating, and (ii) a polymeric carrier resin, preferably a propylene carrier resin,
wherein all weight amounts are based on the total weight of the dry blend, and wherein the components (a) to (c) add up to 100 wt. %.

The dry blend can comprise, and preferably essentially consists of or consists of: (a) 20.0 to 69.99 wt. %, preferably 30.0 to 69.9 wt. %, more preferably 35.0 to 64.8 wt. %, and even more preferably 37.5 to 62.3 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of a linear polypropylene, and
(c) 0.01 to 5.0 wt. %, preferably 0.1 to 4.0 wt. %, more preferably 0.2 to 3.0 wt. %, and even more preferably 0.2 to 2.0 wt. %, of an additive masterbatch, preferably comprising (i) a nucleating agent, more preferably a talc nucleating, and (ii) a polymeric carrier resin, preferably a propylene carrier resin,
wherein all weight amounts are based on the total weight of the dry blend.

In one more specific embodiment, the dry blend comprises:
(a) 55.0 to 64.8 wt. %, like from 57.5 to 62.3 wt. %, of the long chain branched polypropylene,
(b) 35.0 to 44.8 wt. %, like from 37.5 to 62.3 wt. %, of the linear polypropylene, and
(c) 0.2 to 4.0 wt. %, and even more preferably 0.2 to 2.0 wt. %, of an additive masterbatch, preferably comprising (i) a nucleating agent, more preferably a talc nucleating, and (ii) a polymeric carrier resin, preferably a propylene carrier resin,
wherein all weight amounts are based on the total weight of the polypropylene composition, and wherein the components (a) to (c) preferably add up to 100 wt. %.

### Foam

One aspect of the invention provides a foam comprising the polypropylene composition according to one embodiment of the invention.

Another aspect of the invention provides a foam which is obtainable or obtained by the polypropylene composition according to one embodiment of the invention. For example, the foam can be obtainable or obtained from a polypropylene composition as described herein, which is provided in form of a dry blend.

According to one preferred embodiment, a foam is provided having a density of at most 100 kg/m³ and comprising a polypropylene composition, the polypropylene composition comprising
(a) a long chain branched polypropylene, and
(b) a linear polypropylene,
wherein the linear polypropylene has a melt flow rate MFR₂ (ISO 1133, 2.16 kg load, 230° C.) of at least 15.0 g/10 min, and
wherein the linear polypropylene is present in the polypropylene composition in an amount of at least 30.0 wt. %, based on the total weight of the polypropylene composition.

The polypropylene composition may be further defined by one or more embodiments of the polypropylene composition as described herein above in the section “Polypropylene composition for preparing a foam”, including the section “The polypropylene composition” and in the appended claims. The components of the polypropylene composition, such as the long chain branched polypropylene (a), the linear polypropylene (b) and the additives (c) may also be further defined by one or embodiments as described herein above in the section “Long chain branched polypropylene (a)”, “Linear polypropylene (b)”, and “Additives (c)”.

Preferably, the foam comprises at least 95.0 wt. %, and more preferably in the range of 98.0 to 100 wt. %, of the polypropylene composition, based on the total weight of the foam. The foam preferably essentially consists of, or consists of, the polypropylene composition according to one embodiment of the invention.

The foam preferably has a low density. According to one preferred embodiment, the foam has a density of at most 100 kg/m³, and more preferably in the range of 30 to 100 kg/m³, and optionally in the range of 30 to 80 kg/m³, like in the range of 40 to 80 kg/m³.

The foam is preferably provided in form of a foamed article, like a foamed sheet. The foamed sheet can have a thickness of at most 10.0 mm, and preferably in the range of 0.5 to 10.0 mm, like in the range of 0.5 to 7.0 mm.

According to one preferred embodiment, the foam is a foamed sheet having a thickness of at most 10.0 mm, and preferably in the range of 0.5 to 10.0 mm, like in the range of 0.5 to 7.0 mm, and a density of a density of at most 100 kg/m³, and more preferably in the range of 30 to 100 kg/m³, like in the range of 30 to 80 kg/m³.

The foam can have specific properties such as melt strength and shear thinning index.

Preferably, the foam has a melt strength F30 (ISO 16790:2005) of at most 20.0 cN, and more preferably in the range of 5.0 to 20.0 cN.

It is preferred that the foam has a shear thinning index SHI (0.05/300), determined as described herein under “Methods”, of at most 40.0, preferably in the range from 10.0 to 35.0, and more preferably in the range of 10.0 to 30.0.

According to one preferred embodiment of the invention, the foam has both of the following properties:
i) a melt strength F30 (ISO 16790:2005) of at most 20.0 cN, and more preferably in the range of 5.0 to 20.0 cN,
ii) a shear thinning index SHI (0.05/300), determined as described in the specification, of at most 40.0, preferably in the range from 10.0 to 35.0, and more preferably in the range of 10.0 to 30.0.

The foam preferably has a desirable foam structure which can be characterized by the open cell content. The open cell content of the foam is preferably at most 50% (e.g. in the range of 5 to 50%), measured according to ASTM D6226, more preferably at most 45% (e.g. in the range of 5 to 45%), like in the range of 25 to 40%.

The foam can also be characterized by its mechanical properties.

The foam can have an elongation at break of at least 10%, preferably in the range of to 20%, like in the range of 10 to 15%, measured in machine direction (MD) according to ISO 1798. The foam can have an elongation at break of at least 5%, preferably in the range of 5 to 20%, like in the range of 10 to 15%, measured in cross direction (CD) according to ISO 1798.

In one embodiment, the foam has an elongation at break of at least 10%, preferably in the range of 10 to 20%, like in the range of 10 to 15%, measured in machine direction (MD) according to ISO 1798, and an elongation at break of at least 5%, preferably in the range of to 20%, like in the range of 10 to 15%, measured in cross direction (CD) according to ISO 1798.

Furthermore, the foam may have a tensile strength of at least 1050 kPa, preferably in the range of 1050 to 2000 kPa, like in the range of 1250 to 1750 kPa, measured in machine direction (MD) according to ISO 1798.

The foam can have a tensile strength of at least 600 kPa, preferably in the range of 600 to 2000 kPa, like in the range of 700 to 1500 kPa, measured in cross direction (CD) according to ISO 1798.

In one embodiment, the foam has a tensile strength of at least 1050 kPa, preferably in the range of 1050 to 2000 kPa, measured in machine direction (MD) according to ISO 1798, and a tensile strength of at least 600 kPa, preferably in the range of 600 to 2000 kPa, like in the range of 700 to 1500 kPa, measured in cross direction (CD) according to ISO 1798.

According to one embodiment, the foam has one or more of, preferably two or more of, and more preferably all of, the following properties:
i) an open cell content of at most 50%, preferably in the range of 10 to 45%, like in the range of 25 to 40%, measured according to ASTM D6226,
ii) an elongation at break of at least 10%, preferably in the range of 10 to 20%, like in the range of 10 to 15%, measured in machine direction (MD) according to ISO 1798, and
iii) a tensile strength of at least 1050 kPa, preferably in the range of 1050 to 2000 kPa, like in the range of 1250 to 1750 kPa, measured in machine direction (MD) according to ISO 1798.

Thus, the foam can have all of the following properties:
i) an open cell content of at most 50%, preferably in the range of 10 to 45%, like in the range of 25 to 40%, measured according to ASTM D6226,
ii) an elongation at break of at least 10%, preferably in the range of 10 to 20%, like in the range of 10 to 15%, measured in machine direction (MD) according to ISO 1798, and
iii) a tensile strength of at least 1050 kPa, preferably in the range of 1050 to 2000 kPa, like in the range of 1250 to 1750 kPa, measured in machine direction (MD) according to ISO 1798.

According to one more preferred embodiment, the foam has all of the following properties:
i) an open cell content of at most 50%, preferably in the range of 10 to 45%, like in the range of 25 to 40%, measured according to ASTM D6226,
ii) an elongation at break of at least 10%, preferably in the range of 10 to 20%, like in the range of 10 to 15%, measured in machine direction (MD) according to ISO 1798, and
iii) a tensile strength of at least 1050 kPa, preferably in the range of 1050 to 2000 kPa, like in the range of 1250 to 1750 kPa, measured in machine direction (MD) according to ISO 1798,
iv) a shear thinning index SHI (0.05/300), determined as described in the specification, of at most 40.0, preferably in the range from 10.0 to 35.0, and more preferably in the range of 10.0 to 30.0.

In one more specific embodiment, the foam has the following properties:
i) an elongation at break of at least 10%, preferably in the range of 10 to 20%, like in the range of 10 to 15%, measured in machine direction (MD) and in cross direction (CD) according to ISO 1798, and
ii) a tensile strength of at least 1050 kPa, preferably in the range of 1050 to 2000 kPa, like 1050 to 1250 kPa, measured in machine direction (MD) according to ISO 1798,
iii) a tensile strength of at least 700 kPa, preferably in the range of 700 to 2000 kPa, like 700 to 950 kPa, measured in machine direction (MD) according to ISO 1798.

In one more specific embodiment, the foam has the following properties:
i) an elongation at break of at least 10%, preferably in the range of 10 to 20%, like in the range of 10 to 15%, measured in machine direction (MD) and in cross direction (CD) according to ISO 1798, and
ii) a tensile strength of at least 1050 kPa, preferably in the range of 1050 to 2000 kPa, like 1050 to 1250 kPa, measured in machine direction (MD) according to ISO 1798,
iii) a tensile strength of at least 700 kPa, preferably in the range of 700 to 2000 kPa, like 700 to 950 kPa, measured in machine direction (MD) according to ISO 1798,
iv) an open cell content of at most 50%, preferably in the range of 10 to 45%, like in the range of 25 to 40%, measured according to ASTM D6226.

In these specific embodiments, the foam can comprise the more specific polypropylene composition comprising 55.0 to 64.8 wt. % of the long chain branched polypropylene (a) and 35.0 to 44.8 wt. % of the linear polypropylene (b) as described above.

### Use of the Polypropylene Composition

In another aspect, the invention provides a use of the polypropylene composition according to one embodiment of the invention for preparing a foam.

Regarding the possible embodiments and preferred embodiments of the polypropylene composition used for preparing a foam, it is referred to the embodiments and preferred embodiments as described herein above.

In one embodiment, the invention provides a process for preparing a foam, in which a polypropylene composition according to one embodiment of the invention is used.

### Process for Preparing a Foam

Another aspect of the invention provides a process for preparing a foam, preferably as described herein above.

The process comprises the steps of:
a) providing a polypropylene composition according to one embodiment of the invention;
b) foaming the polypropylene composition provided in step a) to obtain a foam.

According to one preferred embodiment of the invention, a process is provided for preparing a foam having a density of at most 100 kg/m³ and comprising a polypropylene composition, the polypropylene composition comprising
(a) a long chain branched polypropylene, and
(b) a linear polypropylene,
wherein the linear polypropylene has a melt flow rate MFR₂ (ISO 1133, 2.16 kg load, 230° C.) of at least 15.0 g/10 min, and
wherein the linear polypropylene is present in the polypropylene composition in an amount of at least 30.0 wt. %, based on the total weight of the polypropylene composition, wherein the process comprises the steps of:
a) providing a polypropylene composition, the polypropylene composition comprising
   (a) a long chain branched polypropylene,
   (b) a linear polypropylene having a melt flow rate MFR₂ (ISO 1133, 2.16 kg load, 230° C.) of at least 15.0 g/10 min and being present in the polypropylene composition in an amount of at least 30.0 wt. %, based on the total weight of the polypropylene composition; and
b) foaming the polypropylene composition provided in step a) to obtain the foam.

The process is preferably an extrusion foaming process. Such processes are known in the art. The process is not limited to a specific extrusion foaming process. The extrusion foaming process may be carried out in a single extruder foaming system or a tandem foam extrusion line.

The process is preferably an extrusion foaming process using a tandem foam extrusion line. Said equipment is known in the art. A tandem extrusion line typically comprises a primary extruder, like a co-rotating twin-screw extruder, for compounding and incorporating the foaming agent, and a secondary extruder, like a single-screw extruder, for cooling the expandable melt.

More preferably, the extrusion foaming process uses a tandem foam extrusion line which is suitable for preparing foam having a density of at most 100 kg/m³.

Preferably, the polypropylene composition is provided in step a) in melt-mixed form, e.g. in a melt mixing device, preferably in an extruder.

More preferably, step a) comprises the steps of:
a1) dry blending the long chain branched polypropylene (a), the linear polypropylene (b), optionally one or more additives (c), and optionally further components to obtain a polypropylene composition in form of a dry blend,
a2) melt mixing the dry blend provided in step a1).

In a preferred embodiment, the one or more additives (c) are present in step a1), e.g. in form of an additive masterbatch. It is further preferred that essentially no additional components other than components (a) to (c) are present in step a1).

It is preferred that step a1) relates to dry blending the long chain branched polypropylene (a), the linear polypropylene (b), and the one or more additives (c), to obtain a polypropylene composition in form of a dry blend.

Melt mixing step a2) can be carried in any suitable melt mixing device, preferably in an extruder of a foam extrusion line. The process conditions and equipment can be selected and adjusted by the skilled person according to the needs.

Step b) relates to the foaming of the polypropylene composition provided in step a), preferably the melt-mixed polypropylene composition, to obtain a foam. The foaming can be accomplished by chemical and/or physical foaming agents.

Step b) is preferably carried out using a physical foaming agent. The physical foaming agent is typically a gas which is suitable for foaming a polymer melt. The gas may be, but is not limited to, butane.

The physical foaming agent is typically injected in the polymer melt during melt-mixing, e.g. in a primary extruder of a tandem foam extrusion line. Subsequently, and optionally after passing a secondary extruder of a tandem foam extrusion line, the expandable melt is subjected to foaming to obtain a foam.

Without limiting the foregoing disclosure in any way, further aspects and embodiments of the present invention are defined in the following, non-limiting numbered items [1] to [15]:
[1] A polypropylene composition for preparing a foam, wherein the polypropylene composition comprises
(a) a long chain branched polypropylene, and
(b) a linear polypropylene,
wherein the linear polypropylene has a melt flow rate MFR₂ (ISO 1133, 2.16 kg load, 230° C.) of at least 15.0 g/10 min, and
wherein the linear polypropylene is present in the polypropylene composition in an amount of at least 30.0 wt. %, based on the total weight of the polypropylene composition.
[2] The polypropylene composition according to item [1], wherein the polypropylene composition comprises:
(a) 20.0 to 70.0 wt. %, preferably 30.0 to 70.0 wt. %, more preferably 35.0 to 65.0 wt. %, and even more preferably 37.5 to 62.5 wt. %, of the long chain branched polypropylene,
(b) 30.0 to 80.0 wt. %, preferably 30.0 to 70.0 wt. %, more preferably 35.0 to 65.0 wt. %, and even more preferably 37.5 to 62.5 wt. %, of the linear polypropylene, and
(c) optionally 0.01 to 5.0 wt. %, preferably 0.1 to 4.0 wt. %, more preferably 0.2 to 3.0 wt. %, and even more preferably 0.2 to 2.0 wt. %, of one or more additives,
wherein all weight amounts are based on the total weight of the polypropylene composition, and optionally wherein the components (a) to (c) add up to 100 wt. %.
[3] The polypropylene composition according to item [1] or [2], wherein the polypropylene composition does not contain a styrene-based polymer.
[4] The polypropylene composition according to any one of items [1] to [3], wherein the polypropylene composition has a melt flow rate MFR₂ (ISO 1133, 2.16 kg load, 230° C.) in the range of 6.0 to 30.0 g/10 min, and preferably in the range of 6.0 to 25.0 g/10 min.
[5] The polypropylene composition according to any one of items [1] to [4], wherein the long chain branched polypropylene is a long chain branched polypropylene homopolymer.
[6] The polypropylene composition according to any one of items [1] to [5], wherein the linear polypropylene is a heterophasic polypropylene composition comprising
a matrix being a polypropylene, preferably a propylene homopolymer or a propylene copolymer, and
an elastomeric ethylene copolymer, preferably a C2C3 copolymer, dispersed in said matrix.
[7] The polypropylene composition according to item [6], wherein the heterophasic polypropylene composition has a xylene cold soluble fraction (according to ISO 16152 at 25° C.) in the range of 10.0 to 45.0 wt. %, preferably in the range of 12.0 to 30.0 wt. %, and more preferably in the range of 12.0 to 22.0 wt. %, based on the total weight of the heterophasic polypropylene composition.
[8] The polypropylene composition according to item [6] or [7], wherein the elastomeric ethylene copolymer, preferably the C2C3 copolymer, has an ethylene content in the range of 25.0 to 70.0 wt. %, preferably in the range of 25.0 to 65.0 wt. %, more preferably in the range of 28.0 to 58.0 wt. %, based on the total weight of the elastomeric ethylene copolymer, determined by quantitative NMR spectroscopy as described in the description in section Methods.
[9] The polypropylene composition according to any one of items [1] to [8], wherein the long chain branched polypropylene has one or more of, preferably two or more of, and more preferably all of, the following properties:
i) a melt strength F30 (ISO 16790:2005) of 20.0 to 50.0 cN, preferably in the range of 25.0 to 45.0 cN, and more preferably in the range of 30.0 to 40.0 cN,
ii) a melt extensibility V30 (ISO 16790:2005) in the range of 190 to 320 mm/s, preferably 210 to 300 mm/s, and more preferably 230 to 280 mm/s,
ii) a melt flow rate MFR₂ (ISO 1133, 2.16 kg load, 230° C.) in the range of 0.5 to 5.0 g/10 min, preferably 1.0 to 3.0 g/10 min, and more preferably 1.2 to 2.5 g/10 min.
[10] The polypropylene composition according to any one of items [1] to [9], wherein the linear polypropylene has a melt flow rate MFR₂ (ISO 1133, 2.16 kg load, 230° C.) in the range of 15.0 to 125.0 g/10 min, preferably 20.0 to 100.0 g/10 min, more preferably 25.0 to 70.0 g/10 min, and most preferably 25.0 to 40.0 g/10 min.
[11] A foam comprising the polypropylene composition according to any one of items [1] to [10].
[12] The foam according to item [11], wherein the foam has a density of at most 100 kg/m³, and preferably in the range of 30 to 100 kg/m³, measured according to ISO 845.
[13] The foam according to item or [12], wherein the foam has one or both of the following properties:
i) a melt strength F30 (ISO 16790:2005) of at most 20.0 cN, and preferably in the range of 5.0 to 20.0 cN,
ii) a shear thinning index SHI (0.05/300), determined as described in the specification, of at most 40.0, preferably in the range from 10.0 to 35.0, and more preferably in the range of 10.0 to 30.0.
[14] The foam according to any one of items to [13], wherein the foam has one or more of, preferably two or more of, and more preferably all of, the following properties:
i) an open cell content of at most 50%, preferably in the range of 5 to 45%, measured according to ASTM D6226,
ii) an elongation at break of at least 10%, preferably in the range of 10 to 20%, measured in machine direction (MD) according to ISO 1798, and
iii) a tensile strength of at least 1050 kPa, preferably in the range of 1050 to 2000 kPa, measured in machine direction (MD) according to ISO 1798.
[15] A process for preparing a foam, wherein the process comprises the steps of:
a) providing a polypropylene composition according to any one of items [1] to [10];
b) foaming the polypropylene composition provided in step a) to obtain a foam.

### EXAMPLES SECTION

### Methods

### Melt Flow Rate (MFR):

The melt flow rates MFR have been determined according to ISO 1133 under a load of 2.16 kg and at a temperature of 230° C.

### Melt Strength F30 and Melt Extensibility v30:

The test described herein follows ISO 16790:2005. The tests were carried out at a pressure of 30 bar.

The strain hardening behaviour is determined by the method as described in the article “Rheotens-Mastercurves and Drawability of Polymer Melts”, M. H. Wagner, Polymer Engineering and Sience, Vol. 36, pages 925 to 935. The content of the document is included by reference. The strain hardening behaviour of polymers is analysed by Rheotens apparatus (product of Göttfert, Siemensstr. 2, 74711 Buchen, Germany) in which a melt strand is elongated by drawing down with a defined acceleration.

The Rheotens experiment simulates industrial spinning and extrusion processes. In principle a melt is pressed or extruded through a round die and the resulting strand is hauled off. The stress on the extrudate is recorded, as a function of melt properties and measuring parameters (especially the ratio between output and haul-off speed, practically a measure for the extension rate). For the results presented below, the materials were extruded with a lab extruder HAAKE Polylab system and a gear pump with cylindrical die (L/D=6.0/2.0 mm). The gear pump was pre-adjusted to a strand extrusion rate of 5 mm/s, and the melt temperature was set to 200° C. The spinline length between die and Rheotens wheels was 80 mm. At the beginning of the experiment, the take-up speed of the Rheotens wheels was adjusted to the velocity of the extruded polymer strand (tensile force zero): Then the experiment was started by slowly increasing the take-up speed of the Rheotens wheels until the polymer filament breaks. The acceleration of the wheels was small enough so that the tensile force was measured under quasi-steady conditions. The acceleration of the melt strand drawn down is 120 mm/sec². The Rheotens was operated in combination with the PC program EXTENS. This is a real-time data-acquisition program, which displays and stores the measured data of tensile force and drawdown speed. The end points of the Rheotens curve (force versus pulley rotary speed) is taken as the F30 melt strength and drawability values.

### Shear Thinning Index SHI_{(0.05/300)}:

The characterization of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression molded plates using nitrogen atmosphere and setting a strain within the linear viscoelastic regime. The oscillatory shear tests were done at 200° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where σ₀, and γ₀ are the stress and strain amplitudes, respectively; ω is the angular frequency; δ is the phase shift (loss angle between applied strain and stress response); t is the time.

Dynamic test results are typically expressed by means of several different rheological functions, namely the shear storage modulus, G′, the shear loss modulus, G″, the complex shear modulus, G*, the complex shear viscosity, η*, the dynamic shear viscosity, η′, the out-of-phase component of the complex shear viscosity, η″ and the loss tangent, tan n, which can be expressed as follows:

$${G}^{′} = \frac{{σ}_{0}}{{γ}_{0}} cos δ [ Pa ] \qquad ( 3 )$$

$${G}^{″} = \frac{{σ}_{0}}{{γ}_{0}} sin δ [ Pa ] \qquad ( 4 )$$

$${G}^{*} = G ‘ + iG “ [ Pa ] \qquad ( 5 )$$

$${η}^{*} = {η}^{′} - i {η}^{″} [ Pa \cdot s ] \qquad ( 6 )$$

$${η}^{′} = \frac{{G}^{″}}{ω} [ Pa \cdot s ] \qquad ( 7 )$$

$$η ” = \frac{{G}^{′} ′}{ω} [ Pa \cdot s ] \qquad ( 8 )$$

The determination of so-called Shear Thinning Index, which correlates with MWD and is independent of Mw, is done as described in equation 9.

$${SHI}_{( x / y )} = \frac{{Eta}^{*} for ( {G}^{*} = x kPa )}{{Eta}^{*} for ( {G}^{*} = y kPa )} \qquad ( 9 )$$

For example, the SHI_{(0.05/300)} is defined by the value of the complex viscosity, in Pa s, determined for a value of G* equal to 0.05 kPa, divided by the value of the complex viscosity, in Pa s, determined for a value of G* equal to 300 kPa.

The values of storage modulus (G′), loss modulus (G″), complex modulus (G*) and complex viscosity (η*) were obtained as a function of frequency (w).

Thereby, e.g. η*_{300 rad/s} (eta*_{300 rad/s}) is used as abbreviation for the complex viscosity at the frequency of 300 rad/s and η*_{0.05 rad/s} (eta*_{0.05 rad/s}) is used as abbreviation for the complex viscosity at the frequency of 0.05 rad/s.

The loss tangent tan (delta) is defined as the ratio of the loss modulus (G″) and the storage modulus (G′) at a given frequency. Thereby, e.g. tan_{0.05} is used as abbreviation for the ratio of the loss modulus (G″) and the storage modulus (G′) at 0.05 rad/s and tan₃₀₀ is used as abbreviation for the ratio of the loss modulus (G″) and the storage modulus (G′) at 300 rad/s.

The elasticity balance tan_{0.05}/tan₃₀₀ is defined as the ratio of the loss tangent tan_{0.05} and the loss tangent tan₃₀₀.

Besides the above mentioned rheological functions one can also determine other rheological parameters such as the so-called elasticity index EI(x). The elasticity index EI(x) is the value of the storage modulus (G′) determined for a value of the loss modulus (G″) of x kPa and can be described by equation 10.

$$EI ( x ) = {G}^{′} for ( {G}^{″} = x kPa ) [ Pa ] \qquad ( 10 )$$

For example, the EI(5 kPa) is the defined by the value of the storage modulus (G′), determined for a value of G″ equal to 5 kPa.

The viscosity eta₇₄₇ is measured at a very low, constant shear stress of 747 Pa and is inversely proportional to the gravity flow of the polyethylene composition, i.e. the higher eta₇₄₇ the lower the sagging of the polyethylene composition.

The polydispersity index, PI, is defined by equation 11.

$$PI = \frac{{10}^{5}}{{G}^{′} ( {ω}_{COP} )} , {ω}_{COP} = ω for ( {G}^{′} = {G}^{″} ) \qquad ( 11 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate y-values to x-values from parameter” and the “logarithmic interpolation type” were applied.

### REFERENCES

[1] “Rheological characterization of polyethylene fractions”, Heino, E. L., Lehtinen, A., Tanner J., Seppälä, J., Neste Oy, Porvoo, Finland, Theor. Appl. Rheol., Proc. Int. Congr. Rheol, 11th (1992), 1, 360-362.
[2] “The influence of molecular structure on some rheological properties of polyethylene”, Heino, E. L., Borealis Polymers Oy, Porvoo, Finland, Annual Transactions of the Nordic Rheology Society, 1995.
[3] “Definition of terms relating to the non-ultimate mechanical properties of polymers”, Pure & Appl. Chem., Vol. 70, No. 3, pp. 701-754, 1998.

### Xylene Cold Soluble (XCS) Fraction):

Xylene Cold Soluble fraction (XCS, wt. %) can be determined at 25° C. according to ISO 16152; 5^{th} edition; 2005 Jul. 1.

### Determination of the C2- and C3-Content in PP Copolymers:

Quantitative nuclear-magnetic resonance (NMR) spectroscopy can be used to quantify the comonomer content and comonomer sequence distribution of the polymers. Quantitative ¹³C{¹H} NMR spectra can be recorded in the solution-state using a Bruker Avance III 400 NMR spectrometer operating at 400.15 and 100.62 MHz for ¹H and ¹³C respectively. All spectra can be recorded using a ¹³C optimised 10 mm extended temperature probehead at 125° C. using nitrogen gas for all pneumatics. Approximately 200 mg of material is dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube is further heated in a rotary oven for at least 1 hour. Upon insertion into the magnet the tube was spun at 10 Hz. This setup can be chosen primarily for the high resolution and quantitatively needed for accurate ethylene content quantification. Standard single-pulse excitation can be employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6k) transients may be acquired per spectra.

Quantitative ¹³C{¹H} NMR spectra may be processed, integrated and relevant quantitative properties determined from the integrals using proprietary computer programs. All chemical shifts can be indirectly referenced to the central methylene group of the ethylene block (EEE) at 30.00 ppm using the chemical shift of the solvent. This approach allows comparable referencing even when this structural unit may not be present. Characteristic signals corresponding to the incorporation of ethylene can be observed, Cheng, H. N., Macromolecules 17 (1984), 1950).

The comonomer fraction can be quantified using the method of Wang et. al. (Wang, W-J., Zhu, S., Macromolecules 33 (2000), 1157) through integration of multiple signals across the whole spectral region in the ¹³C{¹H} spectra. This method may be chosen for its robust nature and ability to account for the presence of regio-defects when needed. Integral regions are slightly adjusted to increase applicability across the whole range of encountered comonomer contents. For systems where only isolated ethylene in PPEPP sequences is observed the method of Wang et. al. may be modified to reduce the influence of non-zero integrals of sites that are known to not be present. This approach reduces the overestimation of ethylene content for such systems and can be achieved by reduction of the number of sites used to determine the absolute ethylene content to:

$$E = 0.5 ( S β β + S β γ + S β δ + 0.5 ( S α β + S α γ ) ) .$$

Through the use of this set of sites the corresponding integral equation becomes:

$$E = 0.5 ( {I}_{H} + {I}_{G} + 0.5 ( {I}_{C} + {I}_{D} ) ) ,$$

using the same notation used in the article of Wang et. al. (Wang, W-J., Zhu, S., Macromolecules 33 (2000), 1157). Equations used for absolute propylene content are not modified.

The mole percent comonomer incorporation can be calculated from the mole fraction:

$$E [ mol - \% ] = 100 * fE .$$

The weight percent comonomer incorporation can be calculated from the mole fraction:

$$E [ wt . - \% ] = 100 * ( fE * 28.06 ) / ( ( fE * 28.06 ) + ( ( 1 - fE ) * 42. 08 ) )$$

### Foam Density:

Foam density was measured according to ISO 845 using an analytical and semi-micro precision balance of Switzerland PRECISA Gravimetrics AG, Switzerland.

### Open Cell Content:

The open cell content was determined according to ASTM D6226.

### Tensile Strength and Elongation:

The tensile strength and elongation at break, in machine direction (MD) and cross direction (CD), were determined according to ISO 1798.

### Starting Materials

Long Chain Branched Polypropylene Starting Material (b-PP):

The long chain branched polypropylene starting material (b-PP) was the product Daploy WB140HMS commercially available from Borealis AG. The polymer has a melt flow rate (ISO 1133, 2.16 kg load, 230° C.) of 2.1 g/10 min, a melt strength F30 (ISO 16790:2005) of about 34 cN, and a melt extensibility V30 (ISO 16790:2005) of about 260 mm/s.

### Linear Polypropylene (I-PP):

L-PP-1: propylene homopolymer available as HE125MO from Borealis AG; the polymer has a melt flow rate (ISO 1133, 2.16 kg load, 230° C.) of 12 g/10 min.
L-PP-2: heterophasic propylene composition comprising a polypropylene matrix and an elastomeric C2C3 copolymer dispersed therein (about 18 wt. % of C2C3 rubber content; about 54 wt. % of C2 content in the rubber phase); the polymer is available as PP612MK10 from SABIC; the polymer has a melt flow rate (ISO 1133, 2.16 kg load, 230° C.) of 33 g/10 min.

### Additive Masterbatch (AM):

A commercially available additive masterbatch (AM) was used. The additive masterbatch contains about 70 wt. % of a talc nucleating agent, and about 30 wt. % of a polypropylene as carrier resin. The polypropylene having a melt index (230° C./2.16 kg) of about 4 g/10 min.

### EXAMPLES

The following dry blends were prepared:
Comparative example CE1:99.2 wt. % b-PP+0.8 wt. % AM
Comparative example CE2:59.0 wt. % b-PP+40.0 wt. % I-PP-1+1.0 wt. % AM
Comparative example CE3:49.0 wt. % b-PP+50.0 wt. % I-PP-1+1.0 wt. % AM
Comparative example CE4:39.0 wt. % b-PP+60.0 wt. % I-PP-1+1.0 wt. % AM
Inventive example IE1:59.0 wt. % b-PP+40.0 wt. % I-PP-2+1.0 wt. % AM
Inventive example IE2:49.0 wt. % b-PP+50.0 wt. % I-PP-2+1.0 wt. % AM
Inventive example IE3:39.0 wt. % b-PP+60.0 wt. % I-PP-2+1.0 wt. % AM

The dry blends were used to prepare low density polypropylene foams using a KraussMaffei Berstorff tandem foaming line (ZE40 twin screw extruded; KE90 single screw extruder) and iso-butane as foaming agent.

The foaming agent was used in an amount in the range of 3.5 to 7.0 wt. %. The twin screw extruded was operated at a temperature in the range of 20 to 220° C. with a screw speed in the range of 100 to 200 r/min and a specific output in the range of 0.2 to 0.7 kg/h/r/min. The single screw extruded was operated at a temperature in the range of 20 to 190° C. with a screw speed in the range of 2 to 15 r/min and a specific output in the range of 5 to 20 kg/h/r/min.

Foam properties are summarized in Table 1 below.

TABLE 1
Examples CE1 to CE4 and IE1 to IE3

| | | CE1 | CE2 | CE3 | CE4 | IE1 | IE2 | IE3 |
|---|---|---|---|---|---|---|---|---|
| b-PP | wt. % | 99.2 | 59 | 49 | 39 | 59 | 49 | 39 |
| I-PP-1 | wt. % | | 40 | 50 | 60 | | | |
| I-PP-2 | wt. % | | | | | 40 | 50 | 60 |
| AM | wt. % | 0.8 | 1 | 1 | 1 | 1 | 1 | 1 |
| MFR (calc.) | g/10 | | 4.2 | 5 | 6 | 6.3 | 8.3 | 11 |
| | min | | | | | | | |
| Foam properties | | | | | | | | |
| Density | kg/m3 | 44 | 49.1 | 53.6 | 56.9 | 56.4 | 54 | 68.5 |
| Open cell | % | 32 | 43.5 | 54.3 | 54.6 | 36 | 39.7 | 33.8 |
| Tensile strength | kPa | 1071 | 1069 | 1247 | 1024 | 1097 | 1362 | 1420 |
| MD | | | | | | | | |
| Tensile strength | kPa | 693 | 683 | 916 | 734 | 748 | 982 | 1148 |
| CD | | | | | | | | |
| Elongation MD | % | 10 | 7 | 7 | 6 | 12 | 12 | 13 |
| Elongation CD | % | 8 | 8 | 10 | 5 | 11 | 7 | 7 |
| SHI | | 49 | 31 | 27 | 23 | 24 | 21 | 16 |
| (Eta0.05/Eta300) | | | | | | | | |

Examples IE1 to IE3 in Table 1 show that the production of a low density polypropylene foam is possible using commercial extrusion foaming process. The linear polypropylene can be added to the blend in an amount of up to 60 wt. %. Furthermore, examples IE1 to IE3 in Table 1 show that processability is improved (lower pressure levels in the melting and cooling extruders) in comparison with example CE1. The open cell content of examples IE1 to IE3 comparably low as the open cell content of the foam of example CE1, and lower than for examples CE2 to CE4. This result confirms the better foam structure of examples IE1 to IE3 in comparison to examples CE2 to CE4. In addition, examples IE1 to IE3 show an improved balance of foam stiffness and elongation at break, especially in machine direction.

Hence, the results show that inventive examples IE1 to IE3 provide foams with an improved cell structure and better mechanical property balance than foams produced from comparative blends.

1. A foam comprising a polypropylene composition, the polypropylene composition comprising:
(a) a long chain branched polypropylene, and
(b) a linear polypropylene,
wherein the linear polypropylene has a melt flow rate MFR₂ (ISO 1133, 2.16 kg load, 230° C.) of at least 15.0 g/10 min, and
wherein the linear polypropylene is present in the polypropylene composition in an amount of at least 30.0 wt. %, based on the total weight of the polypropylene composition and the foam has a density of at most 100 kg/m³.

2. The foam according to claim 1, wherein the polypropylene composition comprises:
(a) 20.0 to 70.0 wt. %, preferably 30.0 to 70.0 wt. % of the long chain branched polypropylene,
(b) 30.0 to 80.0 wt. % of the linear polypropylene, and
(c) optionally 0.01 to 5.0 wt. % of one or more additives,
wherein all weight amounts are based on the total weight of the polypropylene composition, and optionally wherein the components (a) to (c) add up to 100 wt. %.

3. The foam according to claim 1, wherein the polypropylene composition does not contain a styrene-based polymer.

4. The foam according to claim 1, wherein the polypropylene composition has a melt flow rate MFR₂ (ISO 1133, 2.16 kg load, 230° C.) in the range of 6.0 to 30.0 g/10 min.

5. The foam according to claim 1, wherein the long chain branched polypropylene is a long chain branched polypropylene homopolymer.

6. The foam according to claim 1, wherein the linear polypropylene is a heterophasic polypropylene composition comprising:
a matrix being a polypropylene and
an elastomeric ethylene copolymer dispersed in said matrix.

7. The foam according to claim 6, wherein the heterophasic polypropylene composition has a xylene cold soluble fraction (according to ISO 16152 at 25° C.) in the range of 10.0 to 45.0 wt. % based on the total weight of the heterophasic polypropylene composition.

8. The foam according to claim 6, wherein the elastomeric ethylene copolymer has an ethylene content in the range of 25.0 to 70.0 wt. % based on the total weight of the elastomeric ethylene copolymer, determined by quantitative NMR spectroscopy as described in the description in section Methods.

9. The foam according to claim 1, wherein the long chain branched polypropylene has one or both of the following properties:
i) a melt strength F30 (ISO 16790:2005) of 20.0 to 50.0 cN,
ii) a melt extensibility v30 (ISO 16790:2005) in the range of 190 to 320 mm/s.

10. The foam according to claim 1, wherein the long chain branched polypropylene is obtained by treating a linear polypropylene with a radical forming agent, optionally in the presence of bifunctionally unsaturated monomer(s) and/or multifunctionally unsaturated low molecular weight polymer(s).

11. The foam according to claim 1, wherein the linear polypropylene has a melt flow rate MFR₂ (ISO 1133, 2.16 kg load, 230° C.) in the range of 15.0 to 125.0 g/10 min.

12. The foam according to claim 1, comprising at least 95 wt. % of the polypropylene composition, based on the total weight of the foam.

13. The foam according to claim 1, wherein the foam has a density in the range of 30 to 100 kg/m³, measured according to ISO 845.

14. The foam according to claim 1, wherein the foam has one or both of the following properties:
i) a melt strength F₃₀ (ISO 16790:2005) of at most 20.0 cN,
ii) a shear thinning index SHI_{(0.05/300)}, determined as described in the specification, of at most 40.0.

15. The foam according to claim 1, wherein the foam has one or more of the following properties:
i) an open cell content of at most 50% measured according to ASTM D6226,
ii) an elongation at break of at least 10% measured in machine direction (MD) according to ISO 1798, and
iii) a tensile strength of at least 1050 kPa measured in machine direction (MD) according to ISO 1798.

16. A process for preparing a foam according to claim 1, wherein the process comprises the steps of:
a) providing a polypropylene composition, the polypropylene composition comprising:
(a) a long chain branched polypropylene,
(b) a linear polypropylene having a melt flow rate MFR₂ (ISO 1133, 2.16 kg load, 230° C.) of at least 15.0 g/10 min and being present in the polypropylene composition in an amount of at least 30.0 wt. %, based on the total weight of the polypropylene composition; and
b) foaming the polypropylene composition provided in step a) to obtain a foam.

17. The foam according to claim 1, wherein the long chain branched polypropylene has a melt flow rate MFR₂ (ISO 1133, 2.16 kg load, 230° C.) in the range of 0.5 to 5.0 g/10 min.

18. The foam according to claim 6, wherein the matrix polypropylene is a propylene homopolymer or a propylene copolymer, and the elastomeric ethylene copolymer is an elastomeric C2C3 copolymer.

19. The foam according to claim 6, wherein the heterophasic polypropylene composition has a melt flow rate MFR₂ (ISO 1133, 2.16 kg load, 230° C.) in the range of 15.0 to 125.0 g/10 min.

20. The foam according to claim 19, wherein the polypropylene composition comprises:
(a) 30.0 to 70.0 wt. % of the long chain branched polypropylene,
(b) 30.0 to 70.0 wt. % of the linear polypropylene, and
(c) optionally 0.1 to 4.0 wt. %, of one or more additives,
wherein all weight amounts are based on the total weight of the polypropylene composition, and optionally wherein the components (a) to (c) add up to 100 wt. %.
